(19) United States
(12) Patent Application Publication
(10) Pub. No.: US 2017/0029105 A1
(43) Pub. Date: Feb. 2, 2017

(54) COUPLING MECHANISM FOR AIRCRAFT

(71) Applicants: Bran FERREN, Beverly Hills, CA (US); James HIRAHARA, Alhambra, CA (US); Donald G. LARIVIERE, Glendale, CA (US)

(72) Inventors: Bran FERREN, Beverly Hills, CA (US); James HIRAHARA, Alhambra, CA (US); Donald G. LARIVIERE, Glendale, CA (US)

(73) Assignee: NORTHROP GRUMMAN SYSTEMS CORPORATION, Falls Church, VA (US)

(21) Appl. No.: 14/811,575

(22) Filed: Jul. 28, 2015

(51) Int. Cl. B64C 39/02; B64F 3/02; B64F 1/16

(52) U.S. Cl. CPC B64C 39/022; B64F 1/16; B64C 39/024; B64F 3/02; B64C 2201/148; B64C 2201/108

(57) ABSTRACT

A device for connecting an aircraft to a tether secured to the ground includes an attachment mechanism secured to the tether. The attachment mechanism includes a projection having at least one opening. A hoop secured to the aircraft extends through each opening in the attachment mechanism. Each hoop forms a sliding connection with the associated opening such that the attachment member slides along the hoop in response to lateral movement of the aircraft relative to the ground.

### TECHNICAL FIELD

The invention relates to a moveable attachment mechanism for connecting an aircraft to a tether that helps control movement of the aircraft.

### BACKGROUND

Tethered, vertical lift unmanned aerial vehicles (UAVs) are becoming increasingly attractive for applications not requiring unlimited mobility, where power can be supplied from a base station. In such a construction, unlimited flight time with lighter, smaller platforms can be achieved. Current tethers are typically attached to the aircraft via a fixed connection swivel link or similar flexile attachment means below the center of gravity of the aircraft.

### SUMMARY

In accordance with one example, a device for connecting an aircraft to a tether secured to the ground includes an attachment mechanism secured to the tether. The attachment mechanism includes a projection having at least one opening. A hoop secured to the aircraft extends through each opening in the attachment mechanism. Each hoop forms a sliding connection with the associated opening such that the attachment member slides along the hoop in response to lateral movement of the aircraft relative to the ground.

In another example, a device for connecting at least one hoop secured to an aircraft to a tether secured to the ground includes an attachment mechanism having a connecting member for securing to the tether and a projection extending from the connecting member. The projection has an opening for receiving each hoop to form a sliding connecting between each opening and the associated hoop. Each sliding connection maintains alignment with a center of the aircraft during lateral movement of the aircraft relative to the ground.

Other objects and advantages and a fuller understanding of the invention will be had from the following detailed description and the accompanying drawings.

### BRIEF DESCRIPTION OF THE DRAWINGS

FIG. 1 is an example aircraft tethered to the ground with a moveable attachment mechanism.

FIG. 2 is an enlarged view of the attachment mechanism.

FIG. 3 is a cross-sectional view of FIG. 2 taken along line 3-3.

FIG. 4 is a front view of a hoop of the aircraft of FIG. 1.

FIG. 5 is a bottom view of FIG. 1.

FIG. 6 is a schematic illustration of the aircraft of FIG. 1 in a second condition.

FIG. 7 is another example of an aircraft having a moveable attachment mechanism with a release mechanism.

FIG. 8 is an enlarged view of the attachment mechanism of FIG. 7.

FIG. 9 is a schematic illustration of the aircraft of FIG. 7 in a second condition

### DETAILED DESCRIPTION

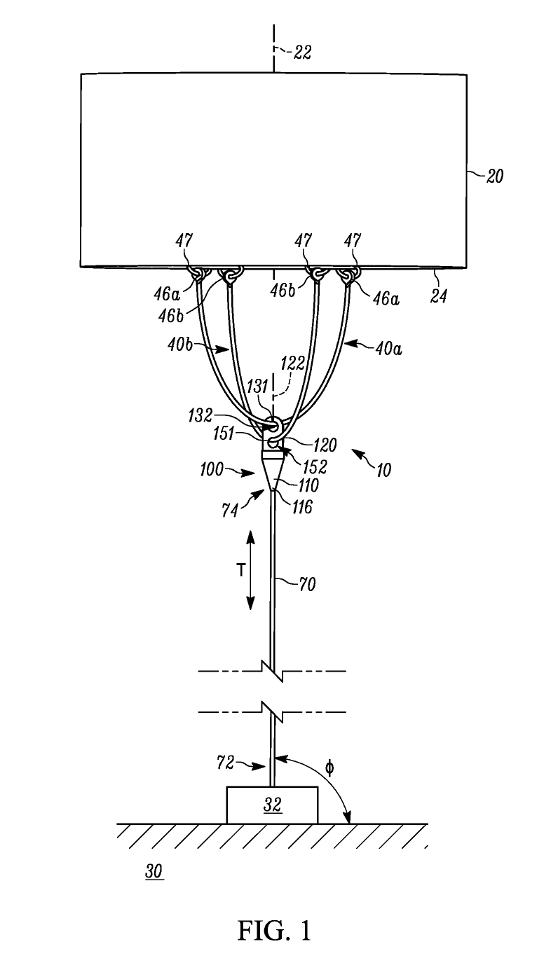

The invention relates to a moveable attachment mechanism for connecting an aircraft to a tether that helps control movement of the aircraft. FIGS. 1-6 illustrate an example aircraft 20 and a device 10 for securing the aircraft to a tether 70, which is connected to a base station 32 on the ground 30. The device 10 includes one or more hoops 40a, 40b and an attachment mechanism 100. The attachment mechanism 100 is secured to the tether 70 extending from the base station 32, and to the hoops 40a, 40b connected to the aircraft 20.

Referring to FIG. 1, the aircraft 20 is schematically illustrated and can be a balloon or unmanned aerial vehicle (UAV), such as an autonomous vehicle or remotely piloted aircraft (drone). The aircraft 20 can be used for military applications, commercial aerial surveillance and motion picture filmmaking, search and rescue, research, surveying, etc. The aircraft 20 has a center of mass along a centerline 22.

The tether 70 constitutes a flexible cable extending from a first end 72 to a second end 74. The first end 72 is secured to the base station 32 on the ground 30. The second end 74 is secured to the attachment mechanism 100. The tether 70 can be formed from Kevlar, steel, aircraft cable or any material(s) capable of supporting loads typical of tethered aircraft. Movement of the aircraft 20 relative to the base station 32 applies varying degrees of tension T to the tether 70 at varying angles Φ relative to the ground 30.

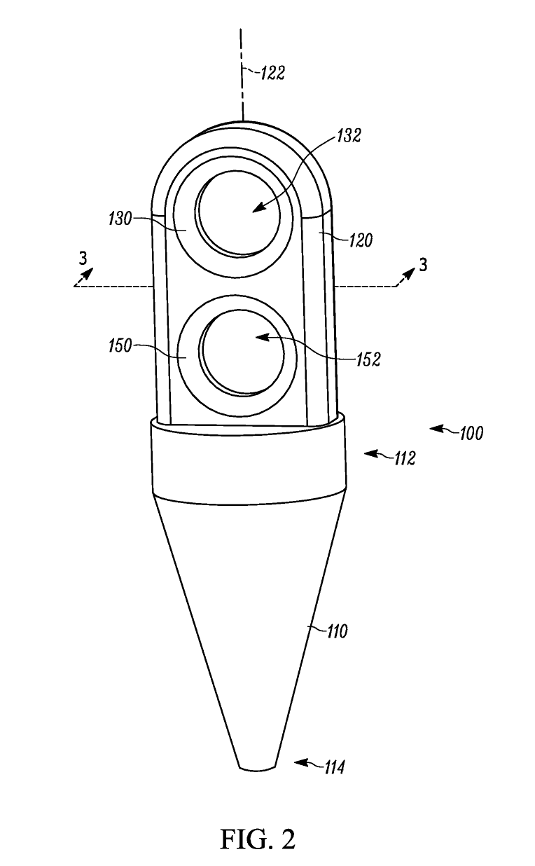

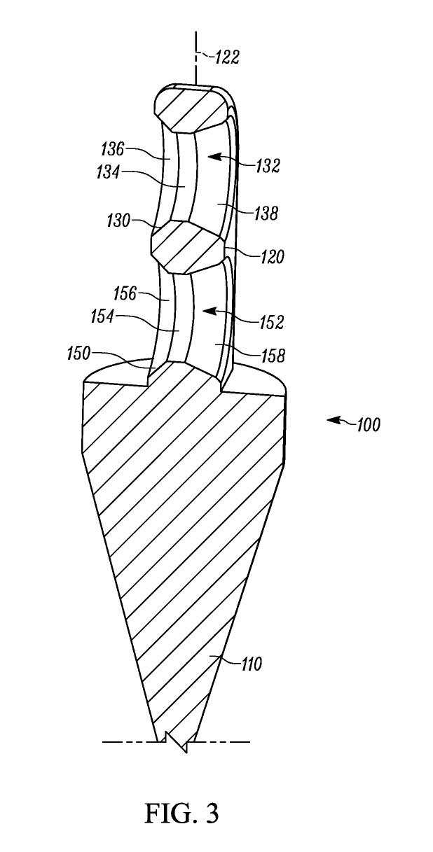

Referring to FIGS. 2 and 3, the attachment mechanism 100 is made from a durable material and includes a connecting member 110 and a projection 120. The connecting member 110 is secured to the second end 74 of the tether 70 at an attachment point 116 (see FIG. 1). The connecting member 110 has a solid, frustoconical shape.

The projection 120 extends from the connecting member 110 and away from the tether 70. The projection 120 has a generally oval shape and extends along a centerline 122. An inner surface 130 defines a round, e.g., circular, first opening 132 extending entirely through the projection 120. The inner surface 130 includes a first portion 134 having a cylindrical shape, a second portion 136 having a frustoconical shape, and a third portion 138 having a frustoconical shape. As shown, the first portion 134 is positioned between the second portion 136 and the third portion 138, with the second and third portions tapering inwards in a direction extending towards the first portion.

An inner surface 150 defines a round, e.g., circular, second opening 152 extending entirely through the projection 120. The inner surface 150 includes a first portion 154 having a cylindrical shape, a second portion 156 having a frustoconical shape, and a third portion 158 having a frustoconical shape. As shown, the first portion 154 is positioned between the second portion 156 and the third portion 158, with the second and third portions tapering inwards in a direction extending towards the first portion. The first and second openings 132, 152 have substantially similar or identical shapes and sizes.

One or more hoops 40a, 40b (FIGS. 1 and 4-5) are secured to the aircraft 20 and extend from a portion of the aircraft 20 towards the attachment mechanism 100. As shown, a pair of hoops 40a, 40b are connected to an underside or bottom 24 of the aircraft 20. It will be appreciated that more or fewer hoops can be secured to the aircraft 20 at any one or more locations, e.g., bottom, top, one or more sides, etc. The hoops 40a, 40b can be formed from Kevlar, steel, aircraft cable or the like.

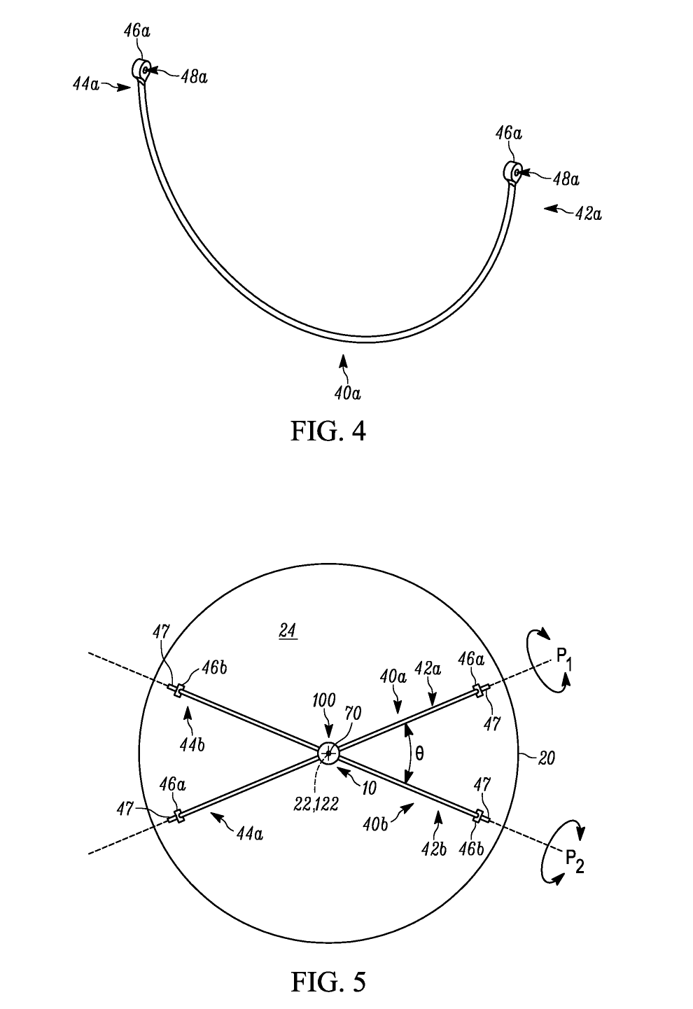

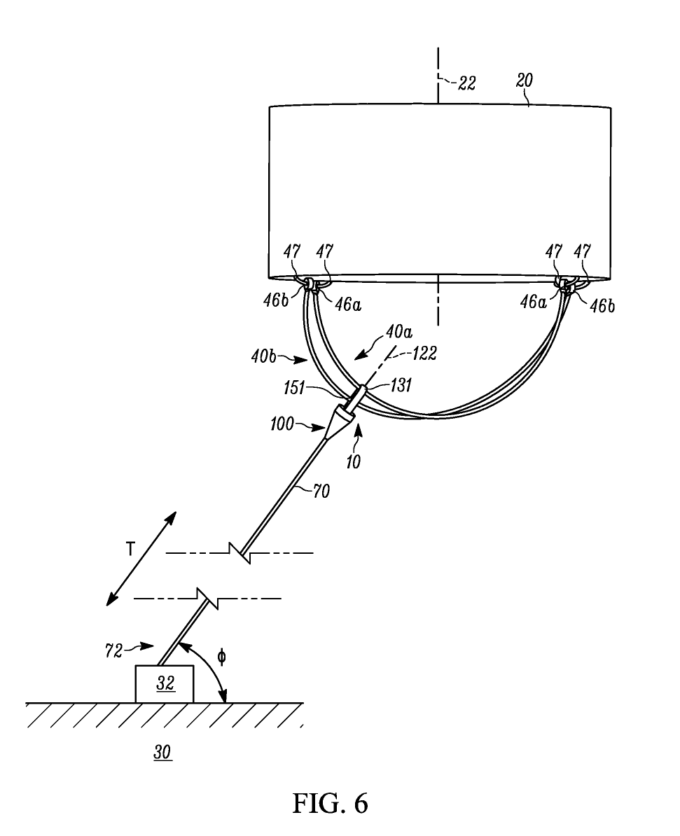

Referring to FIGS. 4-5, the hoop 40a constitutes an elongated body extending from a first end 42a to a second end 44a. The hoop 40a has a round cross-section and includes a projection 46a at each end 42a, 44a. Each projection 46a includes a passage 48a extending entirely therethrough. The projections 46a are secured to the underside 24 of the aircraft 20 so as to pivotably connect the hoop 40a to the aircraft. Although only the hoop 40a is shown in FIG. 4, it will be appreciated that the second hoop 40b, and any subsequent hoop provided (not shown), has the same construction as the hoop 40a. Consequently, the projections 46b on the hoop 40b are also pivotably secured to the underside 24 of the aircraft 20. In one example, pivot pins 47 mounted to the underside 24 of the aircraft 20 extend through each of the passages 68a, 68b on the projections 66a, 66b to pivotably connect the hoops 40a, 40b to the aircraft 20. Each hoop 40a, 40b can pivot about the corresponding pins 47 relative to the aircraft 20 and relative to the other hoop in the manners indicated at P₁ and P₂, respectively (see FIG. 5).

The hoops 40a, 40b extend at an angle, indicated at θ, relative to one another. As shown, the angle θ is acute but could be any non-zero angle up to and including 90°. The hoops 40a, 40b can be made from a flexible material, such as steel cable. The hoops 40a, 40b can be configured to collapse when the aircraft 20 lands and allow the underside 24 or landing gear (not shown) to contact the ground 30 or a docking-type connection (not shown) on the base station 32.

The first hoop 40a extends through the first opening 132 in the projection 120 and engages the inner surface 130 at a first sliding connection 131. The second hoop 40b extends through the second opening 152 in the projection 120 and engages the inner surface 150 at a second sliding connection 151. Subsequent hoops would likewise engage corresponding openings at additional sliding connections (not shown).

Due to the round cross-section of the hoops 40a, 40b, and the configuration of the first and second openings 132, 152, the hoops can readily slide through the openings relative to the projection 120. The frustoconical shapes of the second and third portions 136, 156 and 138, 158 of the openings 132, 152, respectively, as well as the relatively small depth of the first portions 134, 154 helps minimize friction forces between the hoops and projection, thereby facilitating relative movement therebetween. The first and second hoops 40a, 40b therefore are not rigidly attached to the projection 120.

During operation, the aircraft 20 is launched or otherwise positioned in the air directly above the base station 32 sufficient to fully tension T the tether 70 as shown in FIG. 1. Once in place, changes in wind speed, wind direction and/or any propulsion by the aircraft 20 can change the position of the aircraft relative to the base station 32. The attachment mechanism 100 readily accounts for relative movement between the aircraft 20, hoops 40a, 40b, and tether 70 in a manner that maintains alignment between the sliding connections 131, 151 and the center of the aircraft 20 along the centerline 22. When little or no lateral forces act on the aircraft 20 (FIG. 1), the tether 70 extends substantially vertically, i.e., at an angle Φ of about 90° relative to the ground 30. The attachment mechanism 100 is located directly below the aircraft 20 and bifurcates each of the hoops 40a, 40b along their respective lengths. In this configuration, the sliding connections 131, 151 are substantially vertically aligned along the centerline 22 of the aircraft 20. The centerlines 22, 122 are therefore co-axial.

When lateral forces, such as wind or thrust, cause the aircraft 20 to move relative to the base station 32 (FIG. 2) a non-orthogonal angle Φ is formed between the tether 70 and the ground 30 through the connection between the hoops 40a, 40b, attachment mechanism 100, and the tether. Due to the sliding connections 131, 151, however, the attachment mechanism 100 does not maintain a fixed position along the hoops 40a, 40b during movement of the aircraft 20 and tether 70. Rather, as the aircraft 20 moves, the hoops 40a, 40b pivot about the pins 47 in the respective manners P₁, P₂ (see FIG. 5). As this occurs, the hoops 40a, 40b and attachment mechanism 100 slide relative to each other such that the sliding connections 131, 151 maintain alignment with the center of the aircraft 20 along the centerline 22. The attachment mechanism 100 therefore provides a moving connection with the hoops 40a, 40b while staying connected with the tether 70 to keep the aircraft 20 tethered to the base station 32.

The sliding connections 131, 151 are advantageous in that variations in the position of the aircraft 20 do not affect the in-flight stability of the aircraft. Due to the configuration of most UAV the attachment point between the UAV and tether is fixed and cannot practically be placed within the thrust or rotor plane of the UAV. Consequently, the fixed attachment point is generally positioned below the UAV. If, however, the UAV is moved by wind or control problems the tether can be fully tensioned. As a result, the sideward pull of the tether below the payload creates a torque, which pulls the UAV off vertical and creates a sideward thrust component while reducing vertical lift. The altitude of the aircraft is therefore reduced and the possibility of crash rises as the UAV may tilt to a position at which the UAV cannot turn back upright to recover.

In the present invention, however, the attachment mechanism 100 always maintains alignment with the center of the moving aircraft 20 because the sliding connections 131, 151 provide a live pivot point between the attachment mechanism and hoops 40a, 40b. Accordingly, tensile forces T acting on the tether 70 remain aligned with the center of the aircraft 20. As a result, moving the aircraft 20 does not cause the tensioned tether 70 to unevenly apply force to the aircraft, i.e., the tether does not impart moments upon the aircraft. Consequently, vertical lift of the aircraft 20 can be maintained as no torque is produced that pulls or tilts the aircraft off its centerline 22.

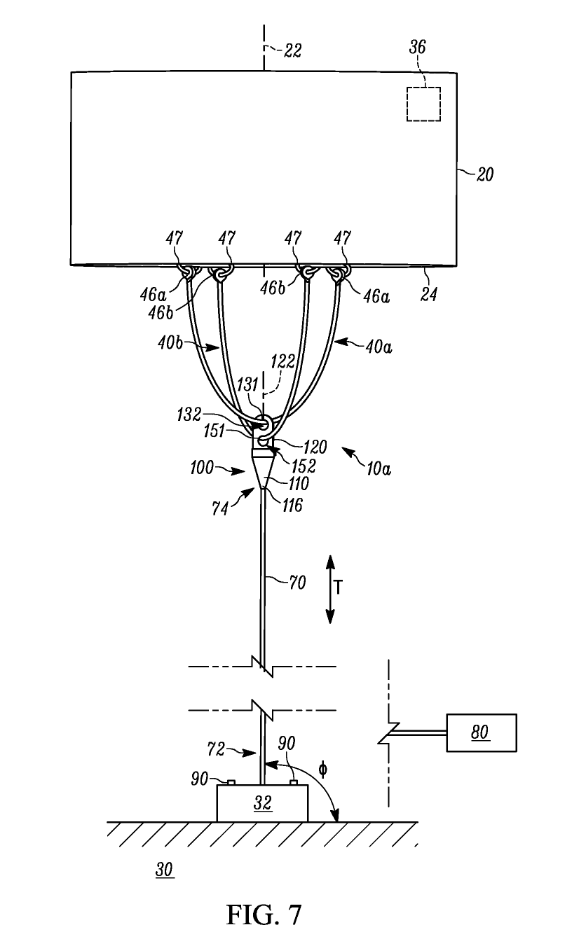

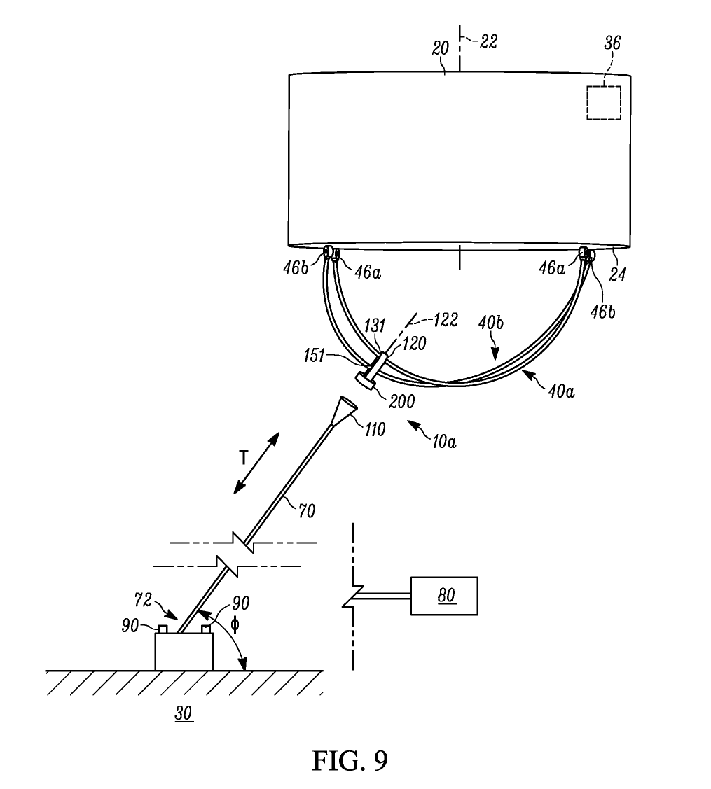

A device 10a in accordance with another example is shown in FIGS. 7-9 and is configured to selectively disconnect the hoops 40a, 40b from the tether 70 in situations where the tension T on the tether exceeds a predetermined amount. The aircraft 20 can include a small battery pack, shown schematically at 36 in FIG. 7, to provide reserve power to the aircraft sufficient to control landing at or near the base station 32 once the tether 70 is disconnected.

One or more force sensors 90 can be provided on the base station 30 for detecting and measuring the direction and magnitude of the tensile forces T experienced by the tether 70. The sensors 90 can be located directly on the base station 32, at the attachment point 116 between the attachment mechanism 100 and the tether 70 or any other suitable location for measuring tensile forces T on the tether.

The measured tensile forces T can be communicated wirelessly or via electrical cables (not shown) to a controller 80 of the aircraft 20 (FIG. 7). The controller 80 is also electrically connected to the aircraft 20 in a manner that enables the aircraft to be controlled during takeoff, flight, landing, etc. Monitoring the tensile forces T on the tether 70 enables more accurate control of the attitude and position of the aircraft 20 under external forces, e.g., wind. The force sensors 90 therefore allow the control system 80 to better compensate for off-vertical forces on the aircraft 20 while exceeding a predetermined force can lead the aircraft 20 to self-detach and recover using onboard power.

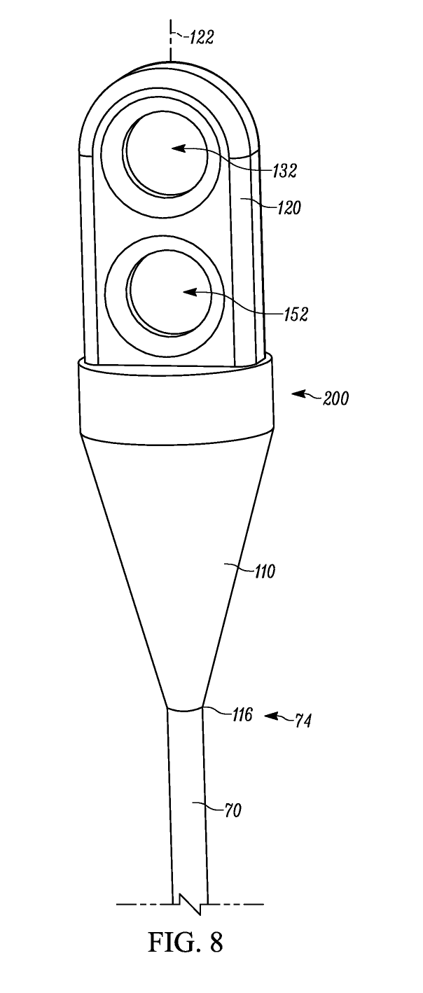

Referring to FIGS. 7 and 8, the projection 120 and connecting member 110 can be connected to one another by a release mechanism, shown schematically at 200. The release mechanism 200 is an electromechanical lock electrically connected to the controller 80 and provided on the projection 120 and/or the connecting member 110. In other words, the release mechanism 200 can constitute any electromechanical device that selectively secures together two components. The release mechanism 200 maintains a secure connection between the projection 120 and connecting member 110 when the measured tensile forces T are below a predetermined amount. The release mechanism 200 is actuated to release the connection between the projection 120 and connecting member 110 when the measured tensile forces T exceed the predetermined amount.

This configuration is advantageous in that the force sensors 90 and release mechanism 200 help prevent damage to the aircraft 20 due to a snagged and/or broken tether 70. The snagging can occur due to obstructions in the flight path of the aircraft 20, e.g., tree branches, power lines, billboards, etc. or unexpected side forces acting on the aircraft 20, such as blowing winds. Both can potentially prevent recovery of the aircraft 20. By reducing the likelihood of damage to the aircraft 20 the sensors 90 and release mechanism 200 permit retrieval of the aircraft 20 for further use, even if the tether 70 becomes snagged or broken.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A device for connecting an aircraft to a tether secured to the ground comprising:
an attachment mechanism secured to the tether and including a projection having at least one opening; and
a hoop secured to the aircraft and extending through each opening in the attachment mechanism, each hoop forming a sliding connection with the associated opening such the attachment member slides along the loop in response to lateral movement of the aircraft relative to the ground.

2. The device of claim 1, wherein the at least one opening comprises a pair of openings, a pair of hoops extending through the openings and being secured to the aircraft at an angle of about 90° from one another.

3. The device of claim 1, wherein each hoop is secured to an underside of the aircraft.

4. The device of claim 1, wherein each opening includes a cylindrical first portion and frustoconical second and third portions, the first portion being positioned between the first and second portions.

5. The device of claim 1, wherein each hoop is pivotably connected to the aircraft.

6. The device of claim 1, wherein lateral movement of the aircraft causes each hoop to pivot relative to the aircraft while sliding through the associated opening in the attachment mechanism.

7. The device of claim 1, wherein each hoop constitutes a metal cable.

8. The device of claim 1 further comprising at least one force sensor for measuring tensile forces on the tether and a controller for controlling the aircraft based upon the measured tensile forces.

9. The device of claim 8, wherein the attachment mechanism includes a release mechanism that is actuated to disconnect the projection from the tether when the measured tensile force exceeds a predetermined amount.

10. A device for connecting at least one hoop secured to an aircraft to a tether secured to the ground comprising:
an attachment mechanism having a connecting member for securing to the tether and a projection extending from the connecting member, the projection having an opening for receiving each hoop to form a sliding connecting between each opening and the associated hoop, wherein each sliding connection maintains alignment with a center of the aircraft during lateral movement of the aircraft relative to the ground.

11. The device of claim 10, wherein each opening includes a cylindrical first portion and frustoconical second and third portions, the first portion being positioned between the first and second portions.

12. The device of claim 10, wherein each hoop slides through the associated opening in the attachment mechanism in response to lateral movement of the aircraft.

13. The device of claim 1 further comprising at least one force sensor for measuring tensile forces on the tether and a controller for controlling the aircraft based upon the measured tensile forces.

14. The device of claim 13, wherein the attachment mechanism includes a release mechanism that is actuated to disconnect the projection from the tether when the measured tensile force exceeds a predetermined amount.

15. The device of claim 13, wherein each hoop constitutes a metal cable.
